(19) United States
(12) Patent Application Publication
(10) Pub. No.: US 2015/0319081 A1
(43) Pub. Date: Nov. 5, 2015

(54) METHOD AND APPARATUS FOR OPTIMIZED NETWORK AND SERVICE PROCESSING

(71) Applicant: Avni Networks Inc., Milpitas, CA (US)

(72) Inventors: Rohini Kumar Kasturi, Sunnyvale, CA (US); Ravi Kanth Nuguru, Cupertino, CA (US); Satish Grandhi, Santa Clara, CA (US); Bhaskar Bhupalam, Fremont, CA (US); Bojjiraju Satya Tirumala Nanduri, Fremont, CA (US); Venkata Siva Satya Phani Kumar Gattupalli, Milpitas, CA (US)

(21) Appl. No.: 14/684,306

(22) Filed: Apr. 10, 2015

Related U.S. Application Data
(63) Continuation-in-part of application No. 14/681,057, filed on Apr. 7, 2015.
Application No. 14/681,057 is a continuation-in-part of application No. 14/214,682, filed on Mar. 15, 2014.
Application No. 14/214,682 is a continuation-in-part of application No. 14/214,666, filed on Mar. 15, 2014.
Application No. 14/214,666 is a continuation-in-part of application No. 14/214,612, filed on Mar. 14, 2014.
Application No. 14/214,612 is a continuation-in-part of application No. 14/214,572, filed on Mar. 14, 2014.
Application No. 14/214,572 is a continuation-in-part of application No. 14/214,472, filed on Mar. 14, 2014.
Application No. 14/214,472 is a continuation-in-part of application No. 14/214,326, filed on Mar. 14, 2014.
(60) Provisional application No. 61/978,699, filed on Apr. 11, 2014.

(51) Int. Cl. H04L 12/707; H04L 29/08; H04L 12/733

(52) U.S. Cl. CPC H04L 45/22; H04L 45/122; H04L 67/2814

(57) ABSTRACT

A fabric system is disclosed. The fabric system may be for a single cloud or multi-cloud environment and includes a services controller. The services controller communicates with at least one of a number of services, which are in turn in communication with an endpoint device. The services controller receives data packets from an open flow switch that is in communication with a client device. The data packets are destined to take a predetermined sub-optimal path through services that are not identical to the services. Based on certain policies, the services controller therefore alters the destined path by re-directing the data packets to an altered path so as to minimize the number of services performed on the data packets and accordingly informs an underlying network of the altered path.

### CROSS-REFERENCE TO RELATED APPLICATIONS

This application claims priority to U.S. Provisional Patent Application No. 61/978,699, filed on Apr. 11, 2014, by Rohini Kumar Kasturi, and entitled “METHOD AND APPARATUS FOR OPTIMIZED NETWORK AND SERVICE PROCESSING”, and is a continuation-in-part of U.S. patent application Ser. No. 14/681,057, filed on Apr. 7, 2015, by Rohini Kumar Kasturi, et al., and entitled “SMART NETWORK AND SERVICE ELEMENTS”, which is a continuation-in-part of U.S. patent application Ser. No. 14/214,682, filed on Mar. 17, 2014, by Kasturi et al. and entitled “METHOD AND APPARATUS FOR CLOUD BURSTING AND CLOUD BALANCING OF INSTANCES ACROSS CLOUDS”, which is a continuation-in-part of U.S. patent application Ser. No. 14/214,666, filed on Mar. 17, 2014, by Kasturi et al., and entitled “METHOD AND APPARATUS FOR AUTOMATIC ENABLEMENT OF NETWORK SERVICES FOR ENTERPRISES”, which is a continuation-in-part of U.S. patent application Ser. No. 14/214,612, filed on Mar. 14, 2014, by Kasturi et al., and entitled “METHOD AND APPARATUS FOR RAPID INSTANCE DEPLOYMENT ON A CLOUD USING A MULTI-CLOUD CONTROLLER”, which is a continuation-in-part of U.S. patent application Ser. No. 14/214,572, filed on Mar. 14, 2014, by Kasturi et al., and entitled “METHOD AND APPARATUS FOR ENSURING APPLICATION AND NETWORK SERVICE PERFORMANCE IN AN AUTOMATED MANNER”, which is a continuation-in-part of U.S. patent application Ser. No. 14/214,472, filed on Mar. 14, 2014, by Kasturi et al., and entitled, “PROCESSES FOR A HIGHLY SCALABLE, DISTRIBUTED, MULTI-CLOUD SERVICE DEPLYMENT, ORCHESTRATION AND DELIVERY FABRIC”, which is a continuation-in-part of U.S. patent application Ser. No. 14/214,326, filed on Mar. 14, 2014, by Kasturi et al., and entitled, “METHOD AND APPARATUS FOR HIGHLY SCALABLE, MULTI-CLOUD SERVICE DEVELOPMENT, ORCHESTRATION AND DELIVERY”, which are incorporated herein by reference as though set forth in full.

### FIELD OF THE INVENTION

Various embodiments of the invention relate generally to cloud-based networks and particularly to optimization of data paths through the network.

### BACKGROUND

Data centers refer to facilities used to house computer systems and associated components, such as telecommunications (networking equipment) and storage systems. They generally include redundancy, such as redundant data communications connections and power supplies. These computer systems and associated components generally make up the Internet. A metaphor for the Internet is cloud.

A large number of computers connected through a real-time communication network such as the Internet generally form a cloud. Cloud computing refers to distributed computing over a network, and the ability to run a program or application on many connected computers of one or more clouds at the same time.

The cloud has become one of, or perhaps even, the most desirable platform for storage and networking. A data center with one or more clouds may have servers, switches, storage systems, and other networking and storage hardware (or equipment), but actually served up by virtual hardware, simulated by software running on one or more networking machines and storage systems. Therefore, virtual servers, storage systems, switches and other networking equipment (sometimes referred to as “elements”) are employed but they do not necessarily exist as equipment or hardware and can therefore be easily altered, moved around and scaled up or down on the fly without any difference to the end user, somewhat like a cloud becoming larger or smaller without being a physical object. Cloud bursting refers to a cloud, including networking equipment, becoming larger or smaller.

Cloud computing allows companies to avoid upfront infrastructure costs, and focus on projects that differentiate their businesses, not their infrastructure. It further allows enterprises to get their applications up and running faster, with improved manageability and less maintenance, and to enable information technology (IT) to more rapidly adjust resources to meet fluctuating and unpredictable business demands.

Fabric computing or unified computing involves the creation of a computing fabric system consisting of interconnected nodes that look like a ‘weave’ or a ‘fabric’ when viewed collectively from a distance. Usually this refers to a consolidated high-performance computing system consisting of loosely coupled storage, networking and parallel processing functions linked by high bandwidth interconnects.

The fundamental components of fabrics are “nodes” (processor(s), memory, and/or peripherals) and “links” (functional connection between nodes). Manufacturers of fabrics (or fabric systems) include companies, such as IBM and Brocade. These companies provide examples of fabrics made of hardware. Fabrics are also made of software or a combination of hardware and software.

Currently, data packets are destined to take a predetermined path through the network, such paths may be “services path”. The path is generally determined statically without an optimization foresight and is therefore less than optimal. The resulting effect is unnecessary delays adversely affecting throughput in addition to wastefulness of precious network resources.

### SUMMARY

Briefly, a fabric system is disclosed. The fabric system may be for a single cloud or multi-cloud environment and includes a services controller. The services controller communicates with at least one of a number of services, which are in turn in communication with an endpoint device. The services controller receives data packets from an open flow switch that is in communication with a client device. The data packets are destined to take a predetermined sub-optimal path through services that are not identical to the services. Based on certain policies, the services controller therefore alters the destined path by re-directing the data packets to an altered path so as to minimize the number of services performed on the data packets and accordingly informs an underlying network of the altered path.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a data center 100, in accordance with an embodiment of the invention.

FIG. 2 shows details of relevant portions of the data center 100 and in particular, the fabric system 106 of FIG. 1.

FIG. 3 shows, conceptually, various features of the data center 300, in accordance with an embodiment of the invention.

FIG. 4 shows, in conceptual form, relevant portions of a multi-cloud data center 400, in accordance with another embodiment of the invention.

FIGS. 4a-c show exemplary data centers configured using various embodiments and methods of the invention.

FIGS. 5-8 show service chains in various networks, in accordance with methods and embodiments of the invention.

FIG. 9 shows a policy-based static service chaining, in accordance with a method and apparatus of the invention.

FIG. 10 shows an example of a content-based dynamic service chaining, in accordance with a method and apparatus of the invention.

FIG. 11 shows, in block diagram form, a relevant portion of a data center with network elements, in accordance with an embodiment and method of the invention.

### DETAILED DESCRIPTION OF VARIOUS EMBODIMENTS

The following description describes a fabric system that may be in a single cloud or multi-cloud environment. The fabric system has a services controller that communicates with at least one of a number of services, which are in turn in communication with an endpoint device. The services controller receives data packets originating from a client device. The data packets are destined to take a predetermined sub-optimal path through certain services. Based on certain policies, the services controller therefore alters the predetermined path by re-directing the data packets to an altered path so as to minimize the number of services performed on the data packets and accordingly informs an underlying network of the altered path.

Although the description has been described with respect to particular embodiments thereof, these particular embodiments are merely illustrative, and not restrictive.

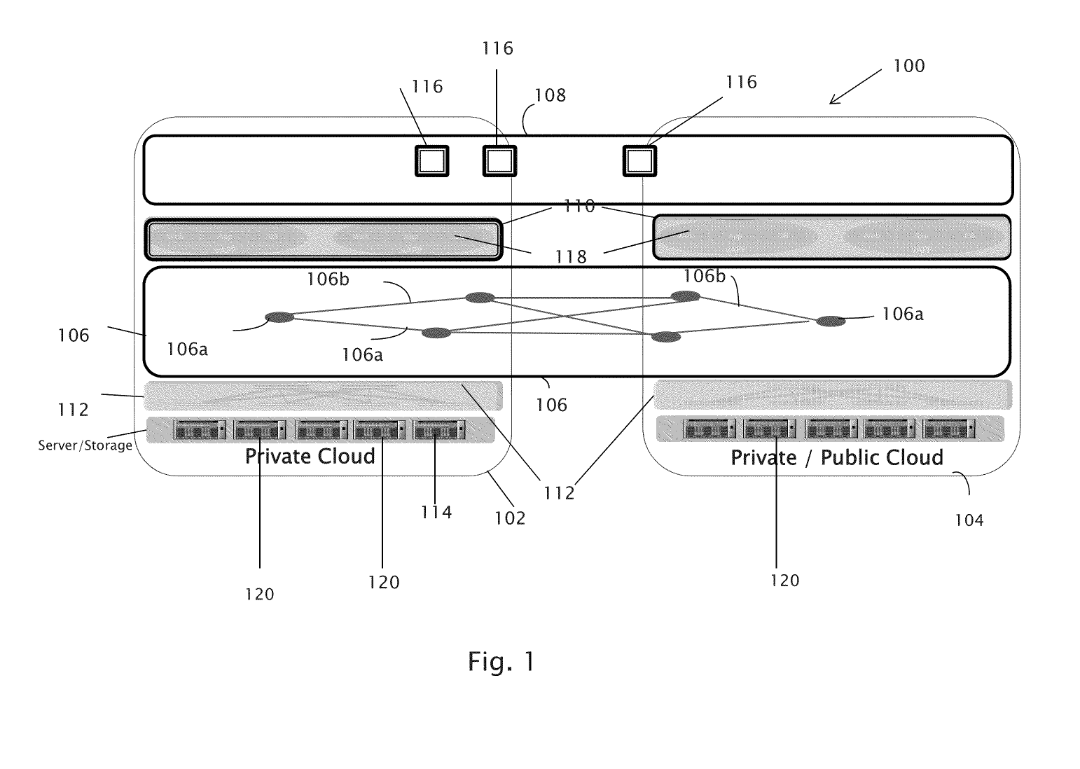

Referring now to FIG. 1, a data center 100 is shown, in accordance with an embodiment of the invention. The data center 100 is shown to include a private cloud 102 and a hybrid cloud 104. A hybrid cloud is a combination public and private cloud. The data center 100 is further shown to include a plug-in unit 108 and a multi-cloud fabric system 106 spanning across the clouds 102 and 104. Each of the clouds 102 and 104 are shown to include a respective application layer 110, a network 112, and resources 114.

The network 112 includes switches, router, and the like and the resources 114 includes networking and storage equipment, i.e. machines, such as without limitation, servers, storage systems, switches, servers, routers, or any combination thereof.

The application layers 110 are each shown to include applications 118, which may be similar or entirely different or a combination thereof.

The plug-in unit 108 is shown to include various plug-ins (orchestration). As an example, in the embodiment of FIG. 1, the plug-in unit 108 is shown to include several distinct plug-ins 116, such as one made by Opensource, another made by Microsoft, Inc., and yet another made by VMware, Inc. The foregoing plug-ins typically each use different formats. The plug-in unit 108 converts all of the various formats of the applications (plug-ins) into one or more native-format applications for use by the multi-cloud fabric system 106. The native-format application(s) is passed through the application layer 110 to the multi-cloud fabric system 106.

The multi-cloud fabric system 106 is shown to include various nodes 106a and links 106b connected together in a weave-like fashion. Nodes 106a are network, storage, or telecommunication or communications devices such as, without limitation, computers, hubs, bridges, routers, mobile units, or switches attached to computers or telecommunications network, or a point in the network topology of the multi-cloud fabric system 106 where lines intersect or terminate. Links 106b are typically data links.

In some embodiments of the invention, the plug-in unit 108 and the multi-cloud fabric system 106 do not span across clouds and the data center 100 includes a single cloud. In embodiments with the plug-in unit 108 and multi-cloud fabric system 106 spanning across clouds, such as that of FIG. 1, resources of the two clouds 102 and 104 are treated as resources of a single unit. For example, an application may be distributed across the resources of both clouds 102 and 104 homogeneously thereby making the clouds seamless. This allows use of analytics, searches, monitoring, reporting, displaying and otherwise data crunching thereby optimizing services and use of resources of clouds 102 and 104 collectively.

While two clouds are shown in the embodiment of FIG. 1, it is understood that any number of clouds, including one cloud, may be employed. Furthermore, any combination of private, public and hybrid clouds may be employed. Alternatively, one or more of the same type of cloud may be employed.

In an embodiment of the invention, the multi-cloud fabric system 106 is a Layer (L) 4-7 fabric system. Those skilled in the art appreciate data centers with various layers of networking. As earlier noted, multi-cloud fabric system 106 is made of nodes 106a and connections (or “links”) 106b. In an embodiment of the invention, the nodes 106a are devices, such as but not limited to L4-L7 devices. In some embodiments, the multi-cloud fabric system 106 is implemented in software and in other embodiments, it is made with hardware and in still others, it is made with hardware and software.

Some switches can use up to OSI layer 7 packet information; these may be called layer (L) 4-7 switches, content-switches, content services switches, web-switches or application-switches.

Content switches are typically used for load balancing among groups of servers. Load balancing can be performed on HTTP, HTTPS, VPN, or any TCP/IP traffic using a specific port. Load balancing often involves destination network address translation so that the client of the load balanced service is not fully aware of which server is handling its requests. Content switches can often be used to perform standard operations, such as SSL encryption/decryption to reduce the load on the servers receiving the traffic, or to centralize the management of digital certificates. Layer 7 switching is the base technology of a content delivery network.

The multi-cloud fabric system 106 sends one or more applications to the resources 114 through the networks 112.

In a service level agreement (SLA) engine, as will be discussed relative to a subsequent figure, data is acted upon in real-time. Further, the data center 100 dynamically and automatically delivers applications, virtually or in physical reality, in a single or multi-cloud of either the same or different types of clouds.

The data center 100, in accordance with some embodiments and methods of the invention, functions as a service (Software as a Service (SAAS) model, a software package through existing cloud management platforms, or a physical appliance for high scale requirements. Further, licensing can be throughput or flow-based and can be enabled with network services only, network services with SLA and elasticity engine (as will be further evident below), network service enablement engine, and/or multi-cloud engine.

As will be further discussed below, the data center 100 may be driven by representational state transfer (REST) application programming interface (API).

The data center 100, with the use of the multi-cloud fabric system 106, eliminates the need for an expensive infrastructure, manual and static configuration of resources, limitation of a single cloud, and delays in configuring the resources, among other advantages. Rather than a team of professionals configuring the resources for delivery of applications over months of time, the data center 100 automatically and dynamically does the same, in real-time. Additionally, more features and capabilities are realized with the data center 100 over that of prior art. For example, due to multi-cloud and virtual delivery capabilities, cloud bursting to existing clouds is possible and utilized only when required to save resources and therefore expenses.

Moreover, the data center 100 effectively has a feedback loop in the sense that results from monitoring traffic, performance, usage, time, resource limitations and the like, i.e. the configuration of the resources can be dynamically altered based on the monitored information. A log of information pertaining to configuration, resources, the environment, and the like allow the data center 100 to provide a user with pertinent information to enable the user to adjust and substantially optimize its usage of resources and clouds. Similarly, the data center 100 itself can optimize resources based on the foregoing information.

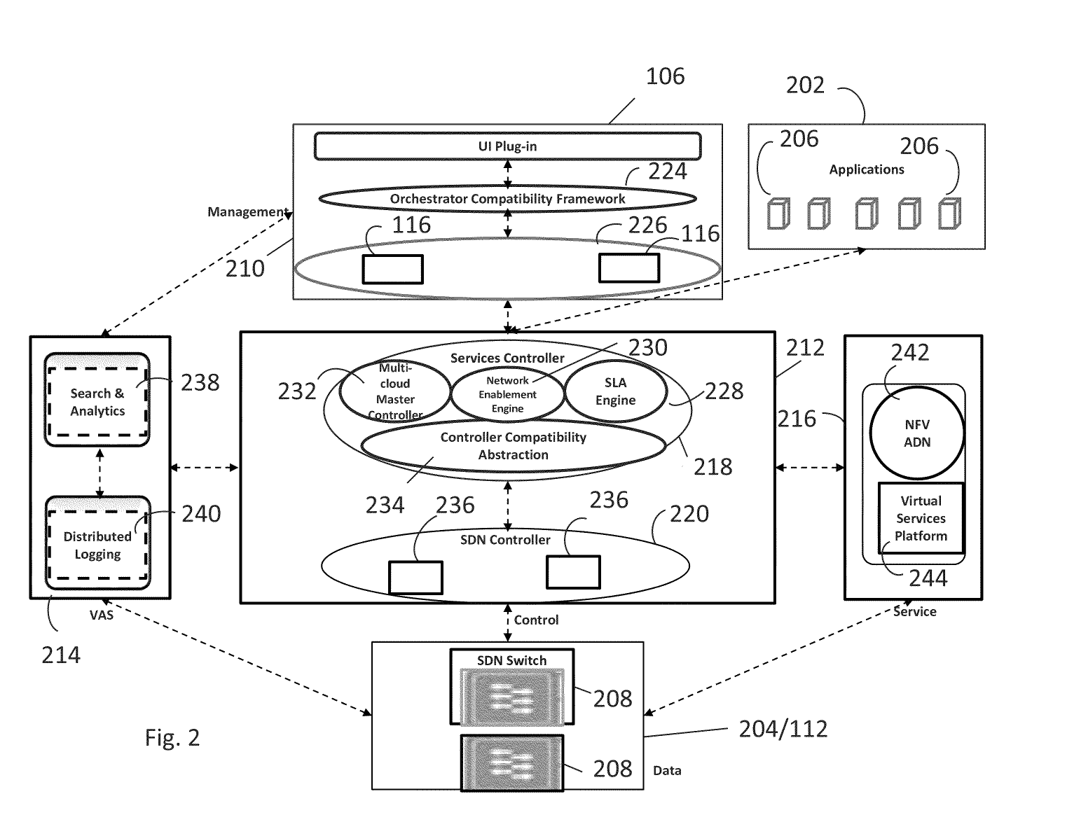

FIG. 2 shows further details of relevant portions of the data center 100 and in particular, the fabric system 106 of FIG. 1. The fabric system 106 is shown to be in communication with a applications unit 202 and a network 204, which is shown to include a number of Software Defined Networking (SDN)-enabled controllers and switches 208. The network 204 is analogous to the network 112 of FIG. 1.

The applications unit 202 is shown to include a number of applications 206, for instance, for an enterprise. These applications are analyzed, monitored, searched, and otherwise crunched just like the applications from the plug-ins of the fabric system 106 for ultimate delivery to resources through the network 204.

The data center 100 is shown to include five units (or planes), the management unit 210, the value-added services (VAS) unit 214, the controller unit 212, the service unit 216 and the data unit (or network) 204. Accordingly and advantageously, control, data, VAS, network services and management are provided separately. Each of the planes is an agent and the data from each of the agents is crunched by the controller unit 212 and the VAS unit 214.

The fabric system 106 is shown to include the management unit 210, the VAS unit 214, the controller unit 212 and the service unit 216. The management unit 210 is shown to include a user interface (UI) plug-in 222, an orchestrator compatibility framework 224, and applications 226. The management unit 210 is analogous to the plug-in 108. The UI plug-in 222 and the applications 226 receive applications of various formats and the framework 224 translates the various formatted application into native-format applications. Examples of plug-ins 116, located in the applications 226, are VMware ICenter, by VMware, Inc. and System Center by Microsoft, Inc. While two plug-ins are shown in FIG. 2, it is understood that any number may be employed.

The controller unit 212 serves as the master or brain of the data center 100 in that it controls the flow of data throughout the data center and timing of various events, to name a couple of many other functions it performs as the mastermind of the data center. It is shown to include a services controller 218 and a SDN controller 220. The services controller 218 is shown to include a multi-cloud master controller 232, an application delivery services stitching engine or network enablement engine 230, a SLA engine 228, and a controller compatibility abstraction 234.

Typically, one of the clouds of a multi-cloud network is the master of the clouds and includes a multi-cloud master controller that talks to local cloud controllers (or managers) to help configure the topology among other functions. The master cloud includes the SLA engine 228 whereas other clouds need not to but all clouds include a SLA agent and a SLA aggregator with the former typically being a part of the virtual services platform 244 and the latter being a part of the search and analytics 238.

The controller compatibility abstraction 234 provides abstraction to enable handling of different types of controllers (SDN controllers) in a uniform manner to offload traffic in the switches and routers of the network 204. This increases response time and performance as well as allowing more efficient use of the network.

The network enablement engine 230 performs stitching where an application or network services (such as configuring load balance) is automatically enabled. This eliminates the need for the user to work on meeting, for instance, a load balance policy. Moreover, it allows scaling out automatically when violating a policy.

The flex cloud engine 232 handles multi-cloud configurations such as determining, for instance, which cloud is less costly, or whether an application must go onto more than one cloud based on a particular policy, or the number and type of cloud that is best suited for a particular scenario.

The SLA engine 228 monitors various parameters in real-time and decides if policies are met. Exemplary parameters include different types of SLAs and application parameters. Examples of different types of SLAs include network SLAs and application SLAs. The SLA engine 228, besides monitoring allows for acting on the data, such as service plane (L4-L7), application, network data and the like, in real-time.

The practice of service assurance enables Data Centers (DCs) and (or) Cloud Service Providers (CSPs) to identify faults in the network and resolve these issues in a timely manner so as to minimize service downtime. The practice also includes policies and processes to proactively pinpoint, diagnose and resolve service quality degradations or device malfunctions before subscribers (users) are impacted.

Service assurance encompasses the following:
Fault and event management
   Performance management
   Probe monitoring
   Quality of service (QoS) management
   Network and service testing
   Network traffic management
   Customer experience management
   Real-time SLA monitoring and assurance
   Service and Application availability
   Trouble ticket management

The structures shown included in the controller unit 212 are implemented using one or more processors executing software (or code) and in this sense, the controller unit 212 may be a processor. Alternatively, any other structures in FIG. 2 may be implemented as one or more processors executing software. In other embodiments, the controller unit 212 and perhaps some or all of the remaining structures of FIG. 2 may be implemented in hardware or a combination of hardware and software.

VAS unit 214 uses its search and analytics unit 238 to search analytics based on distributed large data engine and crunches data and displays analytics. The search and analytics unit 238 can filter all of the logs the distributed logging unit 240 of the VAS unit 214 logs, based on the customer's (user's) desires. Examples of analytics include events and logs. The VAS unit 214 also determines configurations such as who needs SLA, who is violating SLA, and the like.

The SDN controller 220, which includes software defined network programmability, such as those made by Floodlight, Open Daylight, PDX, and other manufacturers, receives all the data from the network 204 and allows for programmability of a network switch/router.

The service plane 216 is shown to include an API based, Network Function Virtualization (NFV), Application Delivery Network (ADN) 242 and on a Distributed virtual services platform 244. The service plane 216 activates the right components based on rules. It includes ADC, web-application firewall, DPI, VPN, DNS and other L4-L7 services and configures based on policy (it is completely distributed). It can also include any application or L4-L7 network services.

The distributed virtual services platform contains an Application Delivery Controller (ADC), Web Application Firewall (Firewall), L2-L3 Zonal Firewall (ZFW), Virtual Private Network (VPN), Deep Packet Inspection (DPI), and various other services that can be enabled as a single-pass architecture. The service plane contains a Configuration agent, Stats/Analytics reporting agent, Zero-copy driver to send and receive packets in a fast manner, Memory mapping engine that maps memory via TLB to any virtualized platform/hypervisor, SSL offload engine, etc.

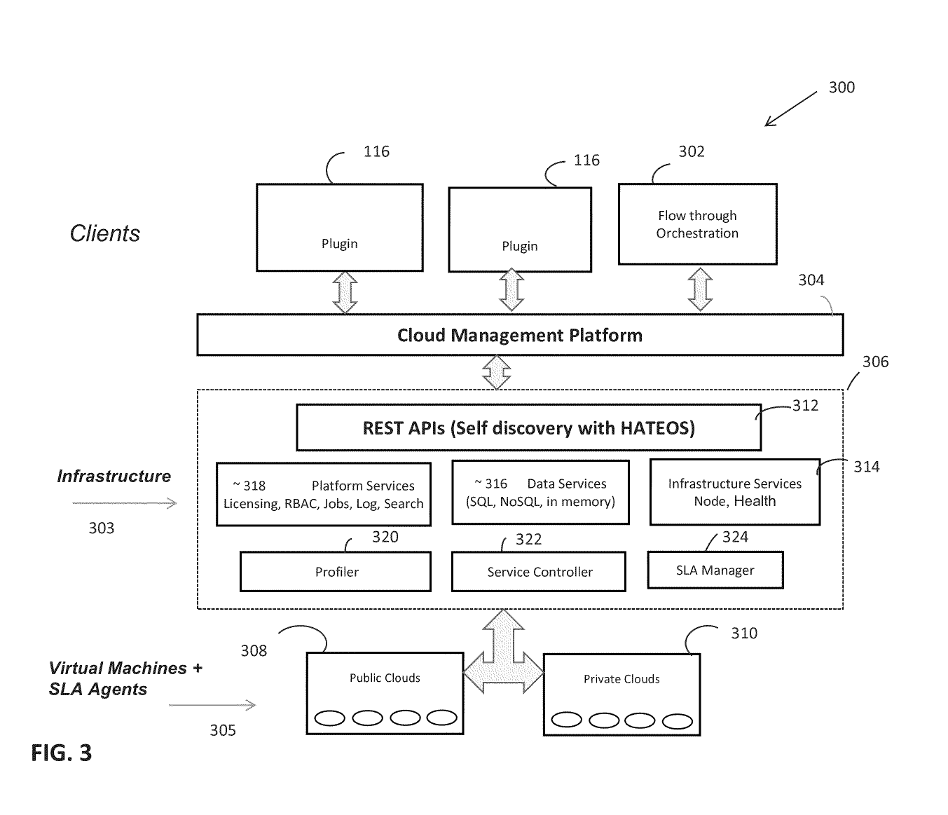

FIG. 3 shows conceptually various features of the data center 300, in accordance with an embodiment of the invention. The data center 300 is analogous to the data center 100 except some of the features/structures of the data center 300 are in addition to those shown in the data center 100. The data center 300 is shown to include plug-ins 116, flow-through orchestration 302, cloud management platform 304, controller 306, and public and private clouds 308 and 310, respectively.

The controller 306 is analogous to the controller unit 212 of FIG. 2. In FIG. 3, the controller 306 is shown to include a REST APIs-based invocations for self-discovery, platform services 318, data services 316, infrastructure services 314, profiler 320, service controller 322, and SLA manager 324.

The flow-through orchestration 302 is analogous to the framework 224 of FIG. 2. Plug-ins 116 and orchestration 302 provide applications to the cloud management platform 304, which converts the formats of the applications to native format. The native-formatted applications are processed by the controller 306, which is analogous to the controller unit 212 of FIG. 2. The RESI APIs 312 drive the controller 306. The platform services 318 is for services such as licensing, Role Based Access and Control (RBAC), jobs, log, and search. The data services 316 is to store data of various components, services, applications, databases such as Search and Query Language (SQL), NoSQL, data in memory. The infrastructure services 314 is for services such as node and health.

The profiler 320 is a test engine. Service controller 322 is analogous to the controller 220 and SLA manager 324 is analogous to the SLA engine 228 of FIG. 2. During testing by the profiler 320, simulated traffic is run through the data center 300 to test for proper operability as well as adjustment of parameters such as response time, resource and cloud requirements, and processing usage.

In the exemplary embodiment of FIG. 3, the controller 306 interacts with public clouds 308 and private clouds 310. Each of the clouds 308 and 310 include multiple clouds and communicate not only with the controller 306 but also with each other. Benefits of the clouds communicating with one another is optimization of traffic path, dynamic traffic steering, and/or reduction of costs, among perhaps others.

The plug-ins 116 and the flow-through orchestration 302 are the clients 310 of the data center 300, the controller 306 is the infrastructure of the data center 300, and the clouds 308 and 310 are the virtual machines and SLA agents 305 of the data center 300.

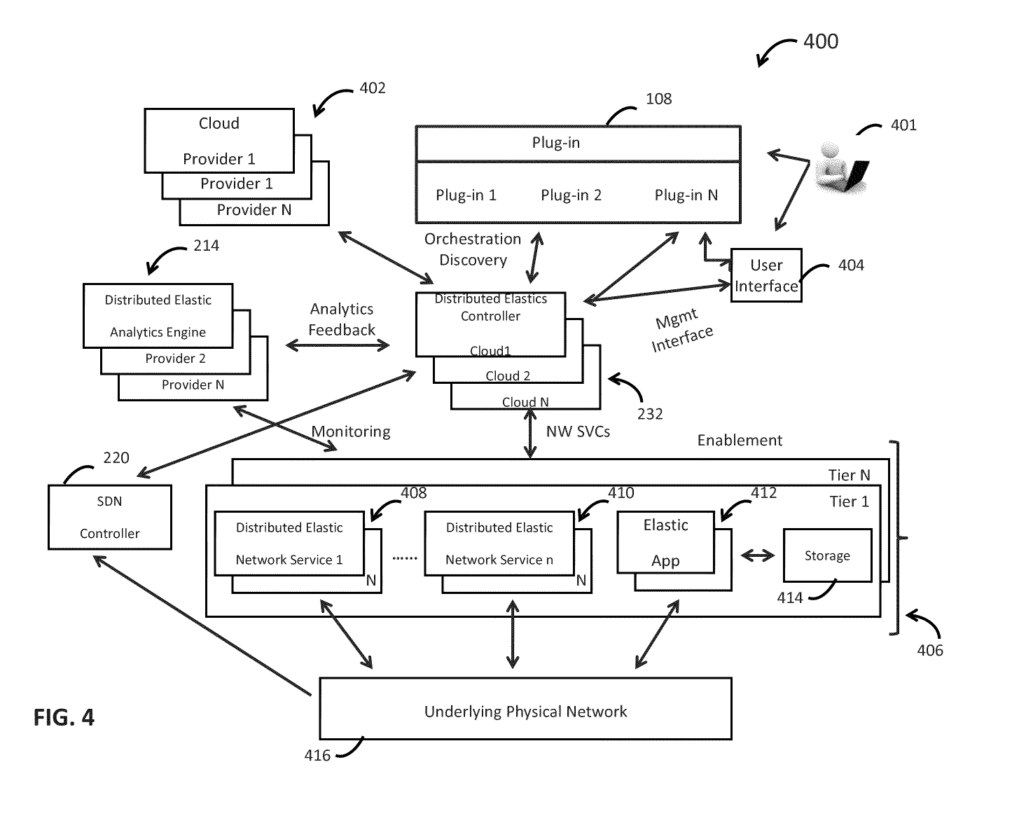

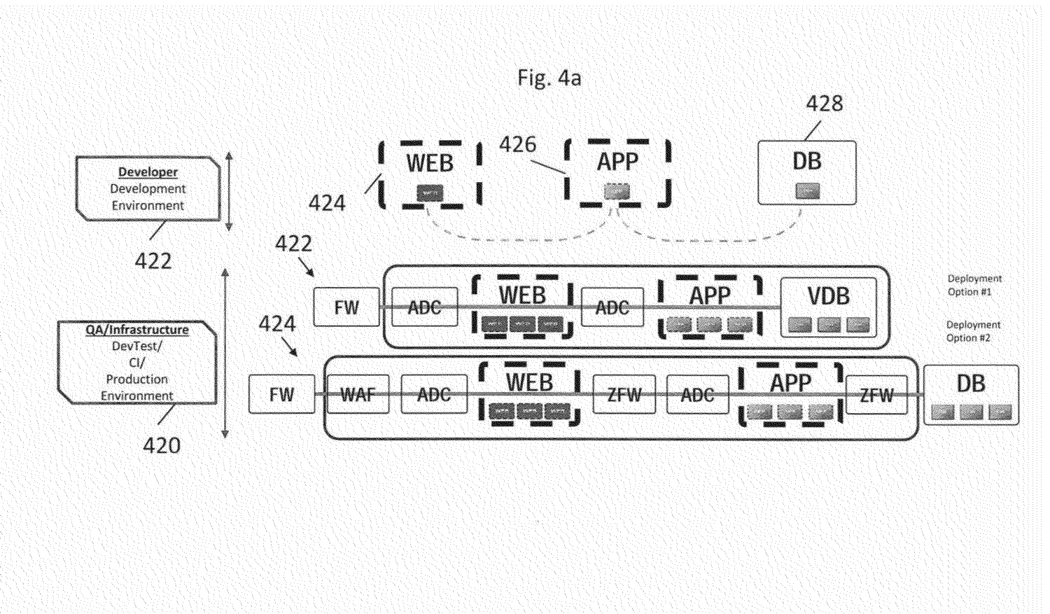

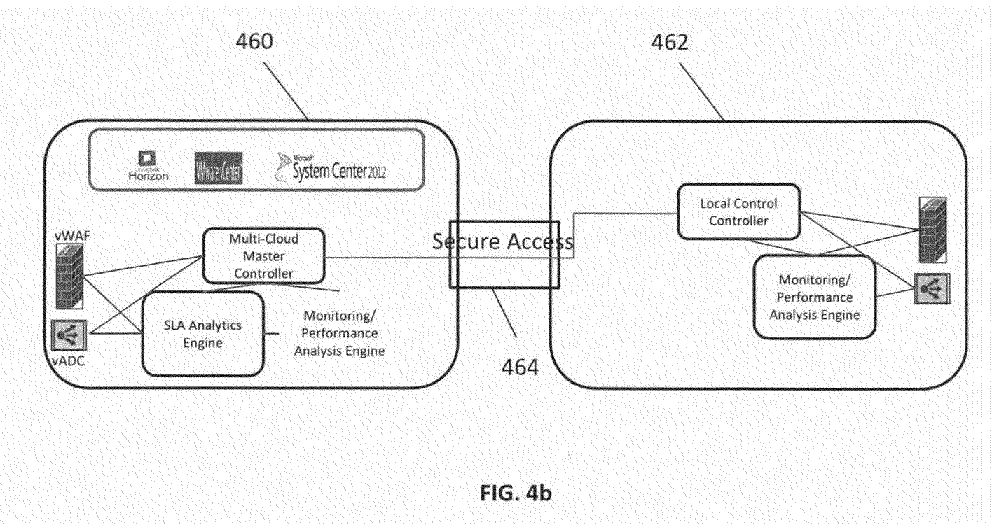

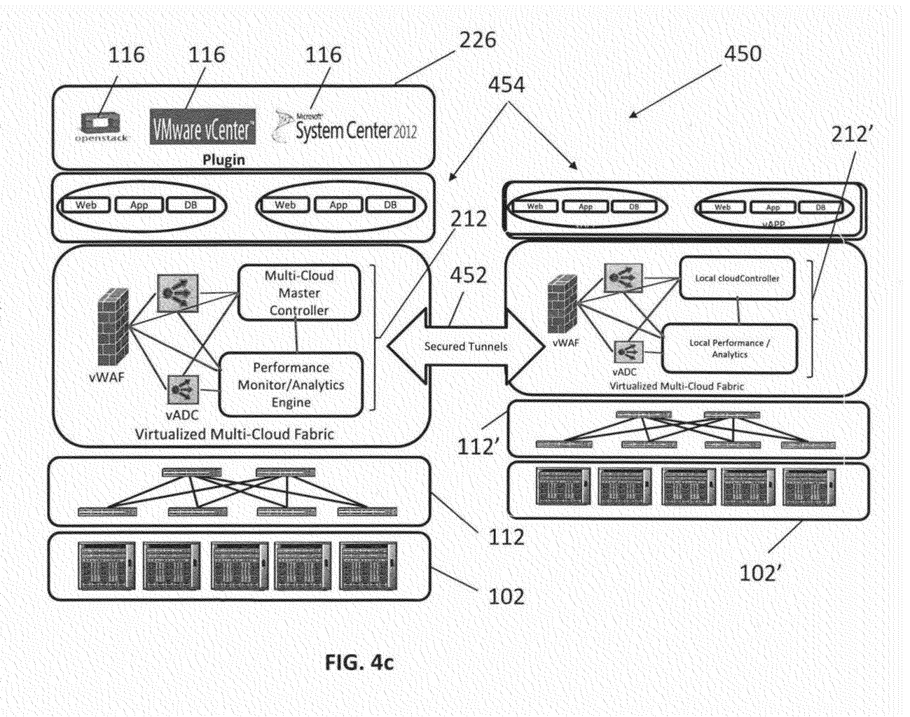

FIG. 4 shows, in conceptual form, relevant portion of a multi-cloud data center 400, in accordance with another embodiment of the invention. A client (or user) 401 is shown to use the data center 400, which is shown to include plug-in units 108, cloud providers 1-N 402, distributed elastic analytics engine (or “VAS unit”) 214, distributed elastic controller (of clouds 1-N) (also known herein as “flex cloud engine” or “multi-cloud master controller”) 232, tiers 1-N, underlying physical NW 416, such as Servers, Storage, Network elements, etc. and SDN controller 220.

Each of the tiers 1-N is shown to include distributed elastic 1-N, 408-410, respectively, elastic applications 412, and storage 414. The distributed elastic 1-N 408-410 and elastic applications 412 communicate bidirectional with the underlying physical NW 416 and the latter unilaterally provides information to the SDN controller 220. A part of each of the tiers 1-N are included in the service plane 216 of FIG. 2.

The cloud providers 402 are providers of the clouds shown and/or discussed herein. The distributed elastic controllers 1-N each service a cloud from the cloud providers 402, as discussed previously except that in FIG. 4, there are N number of clouds, “N” being an integer value.

As previously discussed, the distributed elastic analytics engine 214 includes multiple VAS units, one for each of the clouds, and the analytics are provided to the controller 232 for various reasons, one of which is the feedback feature discussed earlier. The controllers 232 also provide information to the engine 214, as discussed above.

The distributed elastic services 1-N are analogous to the services 318, 316, and 314 of FIG. 3 except that in FIG. 4, the services are shown to be distributed, as are the controllers 232 and the distributed elastic analytics engine 214. Such distribution allows flexibility in the use of resource allocation therefore minimizing costs to the user among other advantages.

The underlying physical NW 416 is analogous to the resources 114 of FIG. 1 and that of other figures herein. The underlying network and resources include servers for running any applications, storage, network elements such as routers, switches, etc. The storage 414 is also a part of the resources.

The tiers 406 are deployed across multiple clouds and are enablement. Enablement refers to evaluation of applications for L4 through L7. An example of enablement is stitching.

In summary, the data center of an embodiment of the invention, is multi-cloud and capable of application deployment, application orchestration, and application delivery.

In operation, the user (or “client”) 401 interacts with the UI 404 and through the UI 404, with the plug-in unit 108. Alternatively, the user 401 interacts directly with the plug-in unit 108. The plug-in unit 108 receives applications from the user with perhaps certain specifications. Orchestration and discover take place between the plug-in unit 108, the controllers 232 and between the providers 402 and the controllers 232. A management interface (also known herein as “management unit” 210) manages the interactions between the controllers 232 and the plug-in unit 108.

The distributed elastic analytics engine 214 and the tiers 406 perform monitoring of various applications, application delivery services and network elements and the controllers 232 effectuate service change.

In accordance with various embodiments and methods of the invention, some of which are shown and discussed herein, a Multi-cloud fabric is disclosed. The Multi-cloud fabric includes an application management unit responsive to one or more applications from an application layer. The Multi-cloud fabric further includes a controller in communication with resources of a cloud, the controller is responsive to the received application and includes a processor operable to analyze the received application relative to the resources to cause delivery of the one or more applications to the resources dynamically and automatically.

The multi-cloud fabric, in some embodiments of the invention, is virtual. In some embodiments of the invention, the multi-cloud fabric is operable to deploy the one or more native-format applications automatically and/or dynamically. In still other embodiments of the invention, the controller is in communication with resources of more than one cloud.

The processor of the multi-cloud fabric is operable to analyze applications relative to resources of more than one cloud.

In an embodiment of the invention, the Value Added Services (VAS) unit is in communication with the controller and the application management unit and the VAS unit is operable to provide analytics to the controller. The VAS unit is operable to perform a search of data provided by the controller and filters the searched data based on the user's specifications (or desire).

In an embodiment of the invention, the multi-cloud fabric system 106 includes a service unit that is in communication with the controller and operative to configure data of a network based on rules from the user or otherwise.

In some embodiments, the controller includes a cloud engine that assesses multiple clouds relative to an application and resources. In an embodiment of the invention, the controller includes a network enablement engine.

In some embodiments of the invention, the application deployment fabric includes a plug-in unit responsive to applications with different format applications and operable to convert the different format applications to a native-format application. The application deployment fabric can report configuration and analytics related to the resources to the user. The application deployment fabric can have multiple clouds including one or more private clouds, one or more public clouds, or one or more hybrid clouds. A hybrid cloud is private and public.

The application deployment fabric configures the resources and monitors traffic of the resources, in real-time, and based at least on the monitored traffic, re-configure the resources, in real-time.

In an embodiment of the invention, the multi-cloud fabric system can stitch end-to-end, i.e. an application to the cloud, automatically.

In an embodiment of the invention, the SLA engine of the multi-cloud fabric system sets the parameters of different types of SLA in rea-time.

In some embodiments, the multi-cloud fabric system automatically scales in or scales out the resources. For example, upon an underestimation of resources or unforeseen circumstances requiring addition resources, such as during a super bowl game with subscribers exceeding an estimated and planned for number, the resources are scaled out and perhaps use existing resources, such as those offered by Amazon, Inc. Similarly, resources can be scaled down.

The following are some, but not all, various alternative embodiments. The multi-cloud fabric system is operable to stitch across the cloud and at least one more cloud and to stitch network services, in real-time.

The multi-cloud fabric is operable to burst across clouds other than the cloud and access existing resources.

The controller of the multi-cloud fabric receives test traffic and configures resources based on the test traffic.

Upon violation of a policy, the multi-cloud fabric automatically scales the resources.

The SLA engine of the controller monitors parameters of different types of SLA in real-time.

The SLA includes application SLA and networking SLA, among other types of SLA contemplated by those skilled in the art.

The multi-cloud fabric may be distributed and it may be capable of receiving more than one application with different formats and to generate native-format applications from the more than one application.

The resources may include storage systems, servers, routers, switches, or any combination thereof.

The analytics of the multi-cloud fabric include but not limited to traffic, response time, connections/sec, throughput, network characteristics, disk I/O or any combination thereof.

In accordance with various alternative methods, of delivering an application by the multi-cloud fabric, the multi-cloud fabric receives at least one application, determines resources of one or more clouds, and automatically and dynamically delivers the at least one application to the one or more clouds based on the determined resources. Analytics related to the resources are displayed on a dashboard or otherwise and the analytics help cause the Multi-cloud fabric to substantially optimally deliver the at least one application.

FIGS. 4a-c show exemplary data centers configured using embodiments and methods of the invention. FIG. 4a shows the example of a work flow of a 3-tier application development and deployment. At 422 is shown a developer's development environment including a web tier 424, an application tier 426 and a database 428, each used by a user for different purposes typically and perhaps requiring its own security measure. For example, a company like Yahoo, Inc. may use the web tier 424 for its web and the application tier 426 for its applications and the database 428 for its sensitive data. Accordingly, the database 428 may be a part of a private rather than a public cloud. The tiers 424 and 426 and database 420 are all linked together.

At 420, development testing and production environment is shown. At 422, an optional deployment is shown with a firewall (FW), ADC, a web tier (such as the tier 404), another ADC, an application tier (such as the tier 406), and a virtual database (same as the database 428). ADC is essentially a load balancer. This deployment may not be optimal and actually far from it because it is an initial pass and without the use of some of the optimizations done by various methods and embodiments of the invention. The instances of this deployment are stitched together (or orchestrated).

At 424, another optional deployment is shown with perhaps greater optimization. A FW is followed by a web-application FW (WFW), which is followed by an ADC and so on. Accordingly, the instances shown at 424 are stitched together.

FIG. 4b shows an exemplary multi-cloud having a public, private, or hybrid cloud 460 and another public or private or hybrid cloud 464 communication through a secure access 464. The cloud 460 is shown to include the master controller whereas the cloud 462 is the slave or local cloud controller. Accordingly, the SLA engine resides in the cloud 460.

FIG. 4c shows a virtualized multi-cloud fabric spanning across multiple clouds with a single point of control and management.

In accordance with embodiments and methods of the invention, load balancing is done across multiple clouds.

Although the description has been described with respect to particular embodiments thereof, these particular embodiments are merely illustrative, and not restrictive.

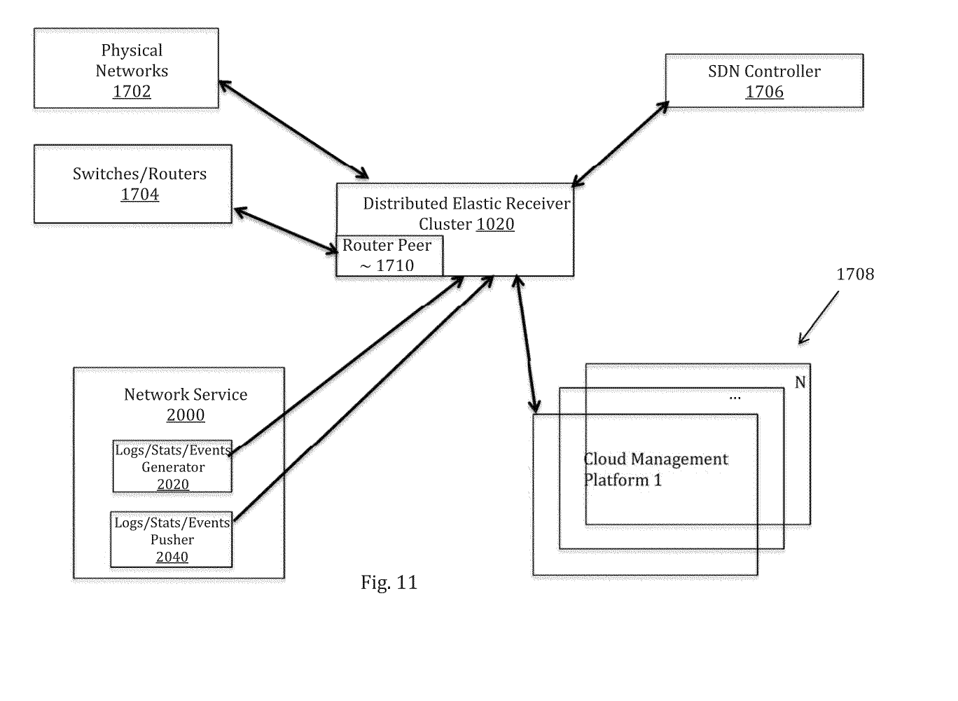

Various embodiments and methods disclose connecting different elements in a chain of layer 4 to layer 7 network service elements and layer 2 to layer 3 network elements, such as routers and switches, of a network. Switches and other networking equipment, such as the switches/routers 1704 shown in FIG. 11 herein, are configured dynamically and on-the-fly as (data or other types of) packets arrive and are sent to a device. Therefore, a path of data packet traffic flow is substantially optimally defined.

For example, the path may be going through a caching service (or server), de-packet subscriber, subscriber database, and the like, called a “service chain”. There are two types of service chains, north-south traffic and east-west traffic. Cable providers or service provider may have within a data center, packets of data moving within the data center, such as the data center 100 of FIG. 1 herein, which is referred to as east-west traffic. A packet goes through a router of a service/cable provider, for example, and subsequently through the internet (of the service provider) and the service/cable provider may have different policies, such as paid subscriber. Based on the policies, certain paths are prescribed for the data packets to reach a data center. Within the data center, an entry point, such as a firewall, receives the data, this is an example of a north-south traffic. De-packet inspection, bandwidth, meter users, and the like are examples of a providers' policies. For example, they dictate the path of the packet to go through a firewall (FW), an acceleration device, . . . . Or they may want to do some analytics.

Traffic going from one endpoint to a destination is generally considered north-south traffic. Currently, service chains are built statically, i.e. static service chains. The problem is that static, as opposed to dynamic, service chains define the service chain based on a worst case scenario such as most anticipated traffic but the rest of the time, the same service chain is used even though many functions are unnecessary. For example, if packets are not accelerated, there is no reason to go through an accelerator. Thus, in accordance with methods and apparatus of the invention, service chains are defined substantially dynamically based on characteristic, such as traffic. Optimized traffic paths and dynamic service chains are therefore realized. Such service chains may be north-south or east-west.

Further examples of the foregoing includes the case where a device may decide not to do a certain task based on certain analytics, such as heuristics. For a financial transaction, for example, another function or service may make more sense. Based on certain criteria a services controller decides to chain or not to chain or what to chain. A customer or user may have its own analytics, and based on these analytics, the services controller makes certain decisions in an effort to define an optimal path. For example the services controller asks if the packet needs to be cached and the caching service lets the controller know if it can cache or not and if it cannot, the services controller re-routes the flow of packets accordingly.

Four methods of optimized network and service processing are shown and discussed. The first method is using a fully transparent proxy-based service in a default provisioned path. However, the default provisioned path is not required subsequently, rather, the path is decision-based based upon request or response of the client.

Another method is half transparent proxy (that modifies source port) based service in the default provisioned path, which is not subsequently required because the path is decision-based based upon the request or response of the client.

A third method is non-transparent proxy (that modifies source IP, source port) based service in the default provisioned path and later decision-based based upon the request or response of the client.

The fourth method is non-transparent proxy (that modifies source IP, source port) based service that is not in the default provisioned path and whether service is required or not is decision-based based upon request for data by the client.

The foregoing four methods, examples of which are shown in FIGS. 1-4, are TCP proxy (various) used to establish connection based on the client's (or customer's).

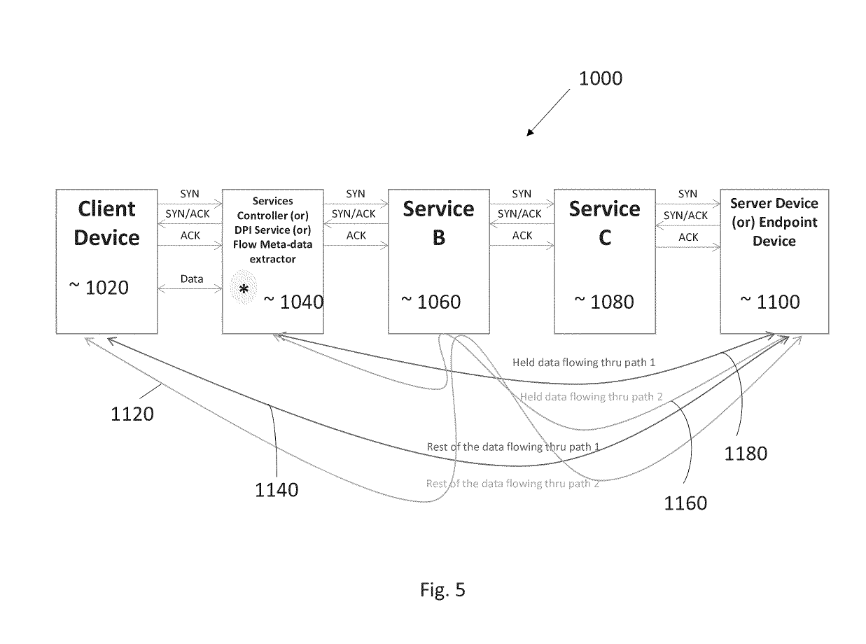

FIG. 5 shows a network 1000, in accordance with an exemplary embodiment of the invention. The network 1000 is shown to include a client device 1020, service(s) controller 1040, a service B 1060, service C 1080, and service device (or endpoint device) 1100. Client device 1020 is the source of the data path, such as a browser. The service(s) controller 1040 is analogous to the service controller 322 of FIG. 3 and in FIG. 5 is shown to include a DPI service or a flow meta-data extractor. The flow meta-data extractor removes meta-data from the packets. The services controller 1040 determines what the client is doing and based on the same, determines a more optimized path for the data to take.

Communication between the blocks of FIG. 5 begins with a “SYN” from a prior device to the next device, a “SYN/ACK” from the next device to the prior device and “ACK” from the previous device to the next device. For example, as shown in FIG. 5, client device 1020 sends “SYN” to services controller 1040, which sends back “SYN/ACK” to the client device 1020. The client device 1020 then sends “ACK” to the services controller 1040. Additionally, data is sent from the client device 1020, as it is received, to the services controller 1040 and the latter determines the path of the data from thereon based on what the client is doing.

Path 1 1180 is shown to go from the services controller 1040 to the endpoint device 1100. An example of this is the client watching U-TUBE. The services controller 1040 determines that no optimization can be done on the U-TUBE data given the services B and C, therefore, it sends the data directly to the endpoint device 1100 rather than going through services B 1060 and/or service C 1100. Accordingly, subsequently, the remaining data, as it is received, is sent directly from the client device 1020 to the endpoint device 1100, as shown by path 1140. This has the effect of saving resources, which translates to cost-savings.

On the other hand, shown at path 2 1160, the services controller 1040 determines that the service B 1060 should be used for optimization of the flow of data path, accordingly, data is sent from services controller 1040 to the service B 1060 and then to the endpoint device 1100. Thus, remaining data is sent directly from the client device 1020 to the service B 1060, and to the endpoint device 1100, as shown by path 1120. Accordingly, service C 1080 is short-circuited in both paths 1 and 2.

An example of the client device 1020 is a browser and an example of the server device 1100 is Yahoo.com (or the Yahoo server). Service B 1060 and service C 1080 are each any value added services (VAS), such as a caching service that anybody wishes to run. The service chain in FIG. 5 is made of services B and C but it is understood that any number of services may be a part of the service chain.

In this manner, the services controller 1040 actively or passively receives packets going through the network to determine the type/heuristics of client and endpoint, such as a video server, web server, etc., in order to determine the L4-L7 services that are required in the traffic path. As an example, non-video traffic does not have to travel through a video optimizer, on the other hand, if the client is a video client, such as ROKU devices, the traffic need not go through data services that are not relevant for video but should go through a video optimizer. Accordingly, service chains are dynamically created based on the client device.

In accordance with a method of the invention, TCP-based services can be short circuited (bypassed) upon receiving the first “SYN” packet, as shown in FIG. 5. In this method, cached information from the services controller about the type of endpoint device can be used to determine the services that are redundant thereby short-circuiting (or eliminating) the redundant services.

In another method of the invention, a static traffic path is first setup (when the first packet arrives) and subsequently the traffic path is optimally re-organized by determining the optimal path based on a user's request/need.

In FIG. 5, service B 1060 and C 1080 support fully transparent TCP proxy, wherein they retain all the TCP parameters intact during the TCP handshake. In this case, when data arrives at the device (services controller) (or) DPI service (or) any external flow meta-data extractor, the services controller determines the type of application and extract all the required meta data to determine optimal paths and (or) service chains. Subsequently, the redundant services are removed from the path and data flows only through the required nodes (or “elements”). In this scenario, service C 1080 is not allowed to timeout and reset the ongoing connection. As shown and discussed relative to subsequent figures, this can be solved by adding a “flow-sniffer” device that can absorb any resets in this case.

The transmission Control Protocol (TCP) is one of the core protocols of the Internet protocol (IP) suite, and is so common that the entire suite is often called TCP/IP. TCP provides reliable, ordered and error-checked delivery of a stream of octets between programs running on computers connected to a local area network, intranet or the public Internet. It resides at the transport layer.

Web browsers use TCP when they connect to servers on the World Wide Web, and it is used to deliver email and transfer files from one location to another. HTTP, HTTPS, SMTP, POP3, IMAP, SSH, FTP, Telnet and a variety of other protocols are typically encapsulated in TCP.

Applications that do not require the reliability of a TCP connection may instead use the connectionless User Datagram Protocol (UDP), which emphasizes low-overhead operation and reduced latency rather than error checking and delivery validation.

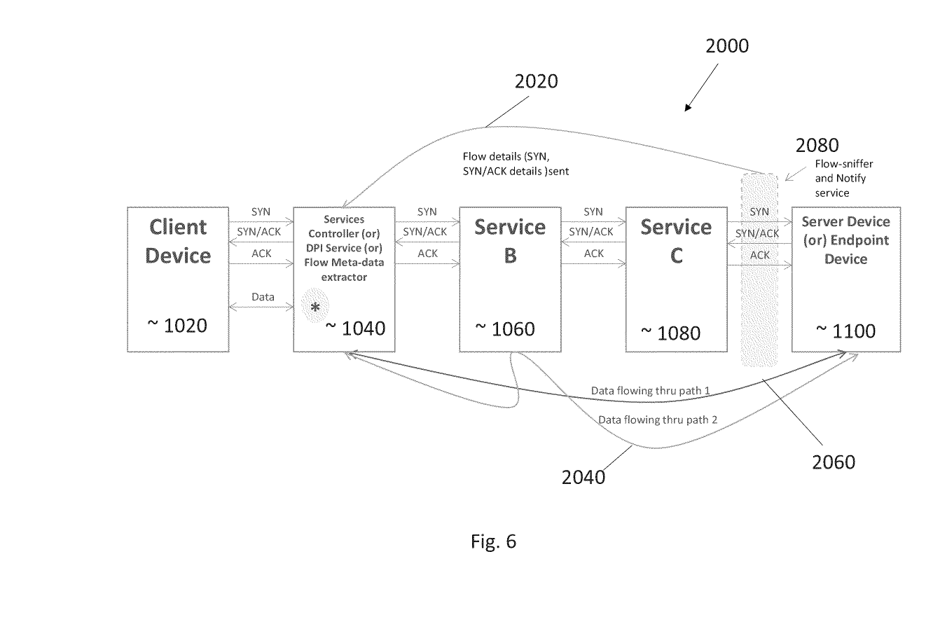

“Flow sniffers” analyzes the flow of traffic. Flow sniffer tells the services controller 104 that, for example, a service has been hijacked. An example of this is presented in FIG. 6.

In FIG. 5, when data is received from the client device 1020, DPI services of the controller 1040 finds out the client's heuristics and looks at subscriber information and other heuristics to determine the path.

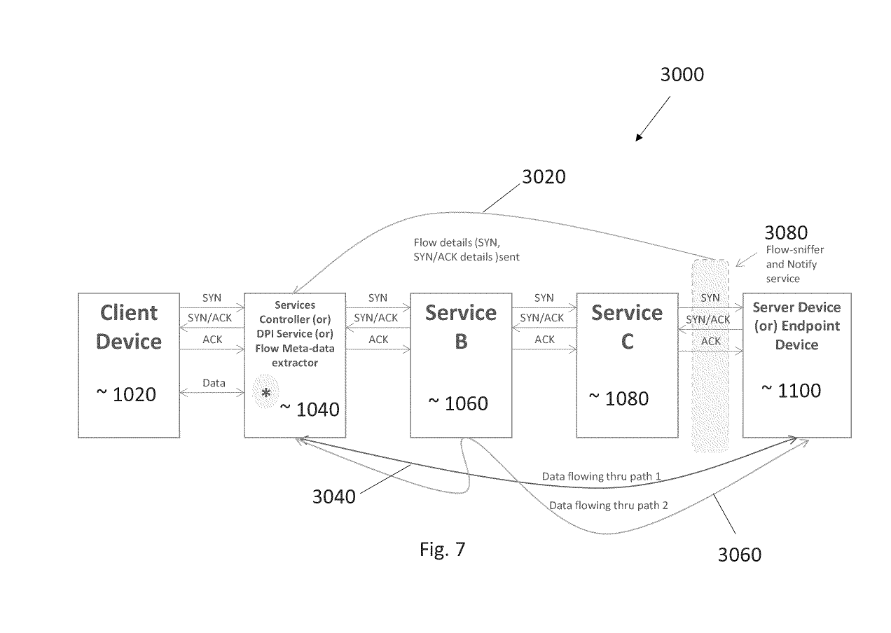

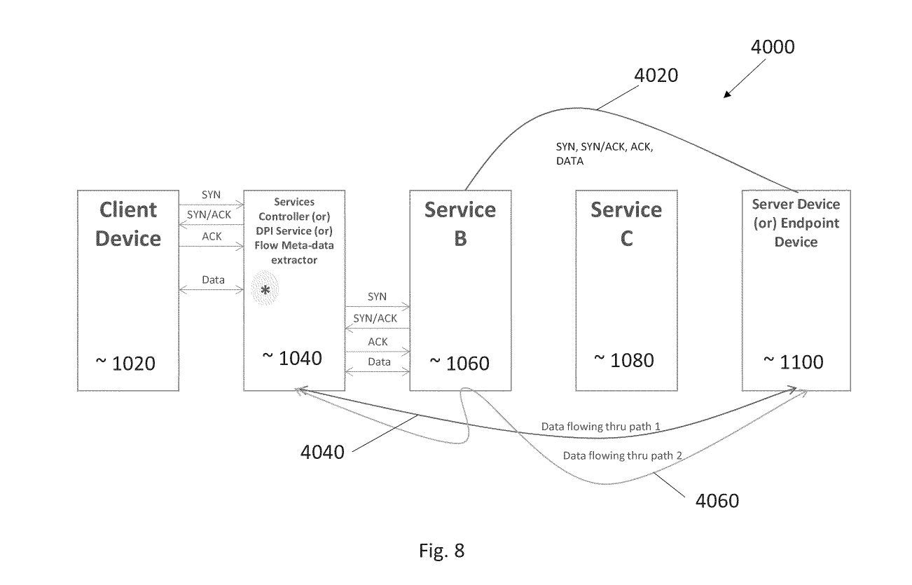

FIG. 5 is an example of a fully transparent proxy-based service. FIG. 6 is an example of a half transparent proxy-based service where the source port is modified. FIG. 7 shows an example of a non-transparent proxy-based service where the source IP and the source port are modified. FIG. 8 shows an example of a non-transparent proxy-based service where the source IP and source port are modified.

In FIG. 6, the IP address is, for example, changed by service C 1080 because the TCP connection has been terminated by service C 1080. But the services controller 1040 does not know this. Because the TCP connection is terminated and the connection needs to be terminated gracefully, this is done by patching up the parameters. The flow-sniffer 2080 knows how to patch because it gathers all of the parameters. In this scenario, service C 1080 terminated the TCP connection and accordingly modified the IP address. As shown by path 2020, the flow-sniffer 2080 notifies the services controller 1040 of the change in the IP address and the services controller 1040 then generates a path accordingly.

The flow-sniffer 2080 looks at the flow, gathers all of the parameters of the flow and determines the services controller of the parameters. The services controller 1040 then makes the decision about the path. The flow-sniffer 2080 can be placed in between other blocks than between the service C and the endpoint device 1100.

In the example of FIG. 7, the flow-sniffer 3080 notifies the services controller 1040 of the source port and IP address change, as shown by the path 3020, and the services controller 1040 then generates the path accordingly. The path 1 2040 is shown to go from the services controller 1040 to the endpoint device 1100 and the path 2 is shown to go from the services controller 1040 to the service B 1060 and then to the endpoint device 1100.

In the example of FIG. 8, no flow-sniffer is needed and service C 1080 does not communicate with service B and the endpoint device 1100, as it did in prior figures.

The services controller 1040 is placed before the first service, which in FIGS. 5-8, is service B 1060. Also, in FIGS. 5-8, for the initial few packets, the service chain is that which the customer has defined and after these packets, remaining packets are sent through other paths or service chain where TCP connections are hijacked.

Full transparent proxy is patched (or “stitched”) in FIG. 5, half transparent proxy is patched in FIG. 6, non-transparent full proxy is patched in FIG. 7, and non-transparent half proxy is patched in FIG. 8.

Accordingly, various embodiments and methods of the invention include the services controller 1040 of the multi-cloud fabric system 1060 is in communication with the client device 1020. The services controller 1040 receives data packets from the client device 1020. The services controller 1040 is also in communication with at least one of service, such as the services 1060 and 1080, which in turn ultimately provide the data packets, after having been serviced, to the endpoint device 1100. An example of an endpoint device 1100, without limitation, is a server device.

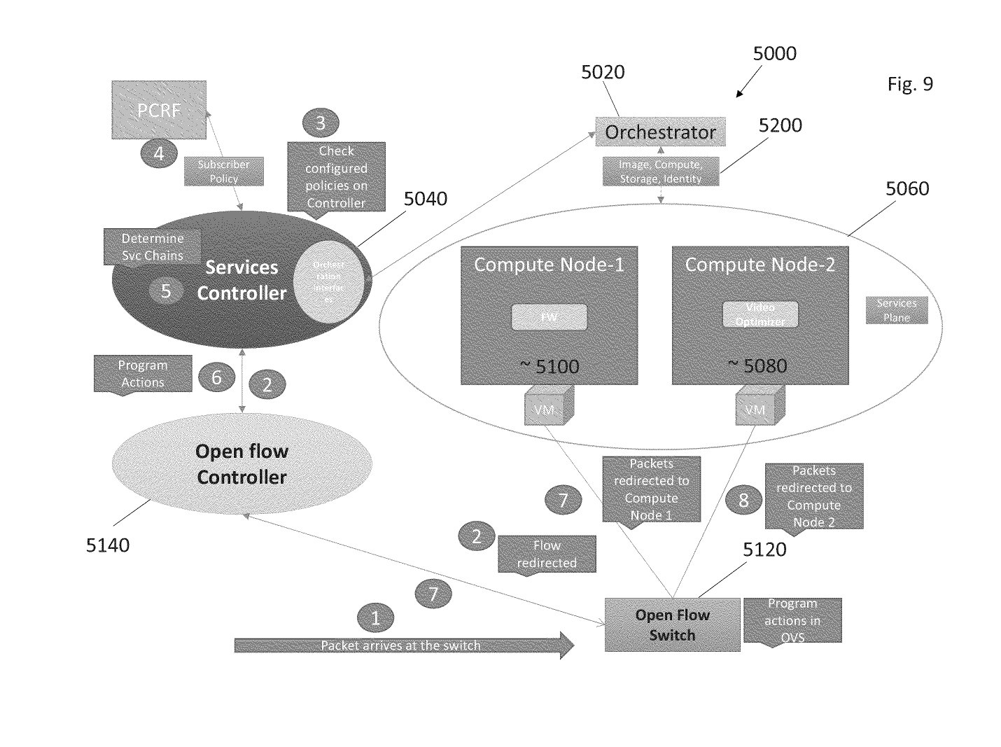

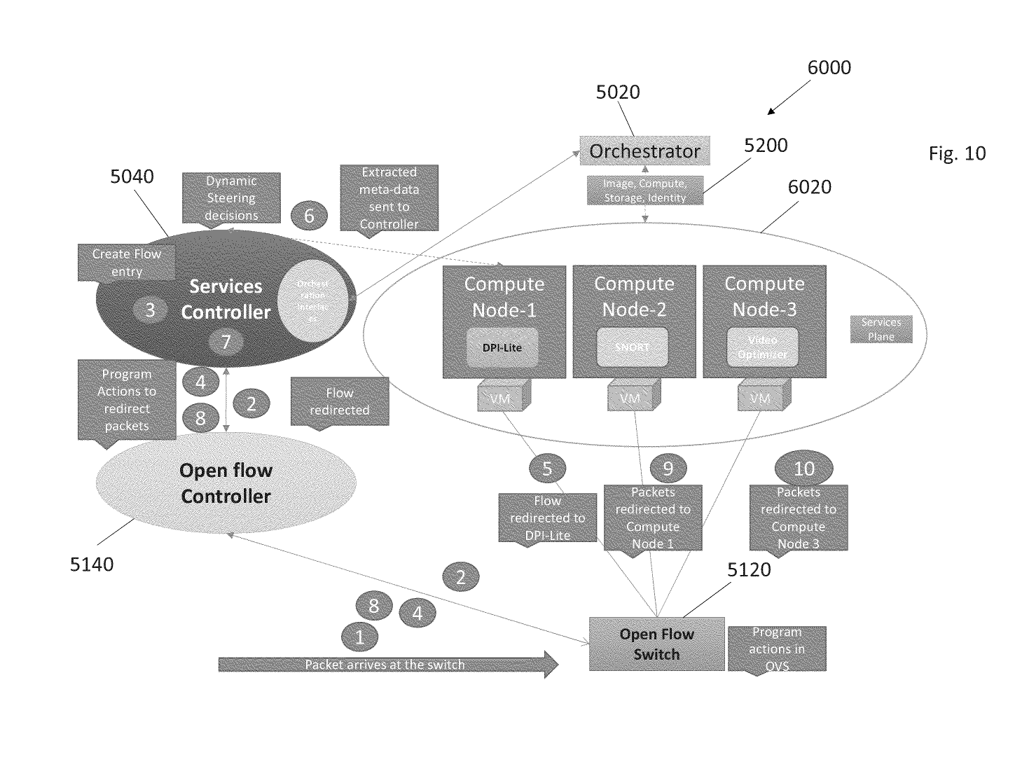

The services controller 1040 receives data packets from the open flow switch 5120 (shown in FIGS. 9 and 10), but the received packets, in some instances, travel a path through the services that is sub-optimal. To optimize the path the data packets are destined to take, based on predetermined policies, the services controller 1040 alters the path by re-directing the data packets to another path that has the data packets travel through a substantially minimal number of services. The services controller 1040 informs the underlying network, such as the network 112 (shown in FIG. 1) of the re-direction. The services controller 1040 may also save the re-directed or altered path for future use. Policies or parameters may be saved in the services controller 1040 or in the PCRF. A number of examples of the above are shown and discussed relative to subsequent figures herein.

In some embodiments, the altered path is saved by the services controller 1040 within or externally to the services controller for future use as discussed below.

In some embodiments, the re-direction is based on policies or parameters. Further, these policies or parameters include information about the content of the data packets therefore, the re-direction is based on the content of the data packets. Alternatively, the re-direction may be based on historical information that is derived from past history of the path. For example, data packets that are destined to take a path that has been taken by the same data packets and the path has been altered by the service controller 1040 already, the same path may be employed without re-determining it. Yet alternatively, past or present (or both) actions or behavior of the user may be used to determine the re-directed path. Still alternatively, user-defined parameters may be employed to determine the re-direction or the user may define the re-direction.

FIG. 9 shows a policy-based static service chaining, in accordance with a method and apparatus of the invention.

As shown in FIG. 9, at “1”, a packet of data is received by the open flow switch 5120 and the flow is redirected at “2”. Next, at “3”, the services controller 5040, which is analogous to the services controller 1040 of prior figures, checks the configured policies and at “4”, it uses Policy and Charging Rules Function (PCRF) is a policy where a software node is designated in real-time to determine policy rules. At this time, the services controller 504 is ready to determine a substantially optimized services chain at “5”. Program actions are taken at “6”. At “7” and “8”, data packets are re-directed to nodes 5060. The nodes 5060 are shown to include compute node 1 5100 and compute node 2 5080 with the former including a firewall (FW) and the latter including a video optimizer. At “7”, packets are re-directed to node 5100 and at “8”, packets are re-directed to node 508. Each of the nodes 5080 and 5100 has an associated virtual machine (VM). The open flow switch 5120 is a part of the network 112 (shown in FIG. 1) or the switches 208 (shown in FIG. 2) or the NW 416 (shown in FIG. 4). The open flow controller 5140 the block 236 of FIG. 2 or the controller 220 of FIG. 4. The terms “open flow” and “SDN”, as used herein are synonymous.

FIG. 10 shows content-based dynamic service chaining, in accordance with a method and apparatus of the invention. At “1”, a packet of data is received by the open flow switch 5120. At “2”, the packet is sent to the open flow controller 5140. Next, at “3”, a flow entry is created by the services controller 5040. “Flow entry” refers to an entry in the flow table of the Layer 2 switch that contains the actions that will be taken on packets matching the criteria mentioned in the flow entry.

Next, at “4”, actions to re-direct packets are programmed and at “5”, the flow of data is redirected from VM of the compute node 1 of the compute nodes 6020 to the open flow switch 5120. At “6”, meta-data is extracted and sent to the services controller 5040 based on which the services controller makes dynamic steering decisions which will alter the path of the flow. At “7” and “8”, the services controller 5040 programs actions to redirect packets and at “9”, packets are redirected to the VM of compute node 2 and at “10”, packets are redirected to compute node 3. FIG. 10 shows an example of a content-based dynamic service chaining, in accordance with a method and apparatus of the invention. The two 8's, two 4's and two 2's represent a pair of actions. Flow (re)programming is done by sending commands to the OpenFlow Controller which in turn sends it to the OpenFlow switch. These are done in pairs.

Thus, according to various embodiments and methods of the invention, multiple network services of a network (system), such as load balancers, fire walls, proxy servers, caching servers, and others, packets that flow through the network are set to follow a path that is dynamically determined based on policies that are generally determined by the user's use of services or perhaps directly by the user. In some embodiments, current as well as historical behavior of the user is a factor in determining an optimal path. In this respect, the history and/or current use of the user's behavior is used to dynamically change the path data is taken through service chains.

In summary, according to a method and embodiment of the invention, the network (system) 1000 of FIG. 5 therefore uses its service controller 1040 to communicate with a client device, such as client device 1020 of FIG. 5, and at least one service. The service(s), such as services 1060 and 1080 of FIG. 5, are in communication with a server device (or endpoint device), such as the device 1100 of FIG. 5.

The service controller 1040, upon receiving one or more packets of data from an open flow switch, such as the switch 512 of FIG. 9, with a sub-optimal services path, checks predetermined policies, which may be from the Policy and Charging Rules Function (PCRF) (or a storage location within the PCRF) or the configured policies saved in a storage location within the services controller (shown in FIG. 9). Based on the predetermined policies, the services controller 1040 determines a substantially optimized services path for the packets of data through the network, such as the path 1140 or 1160 in the examples provided above with reference to FIG. 5.

The service controller 1040 then informs the corresponding network of the optimized path (also referred to as “program actions”) and the path of the data packets is re-directed through the optimized services path instead. The optimized services path either has at least one service in common with the original path but is not an identical path as the original path.

In accordance with an embodiment and method of the invention, the substantially optimized path is dynamic and changes based on policies and/or even the user's input or even the content of the data packets using deep packet inspection. Based on the content of the data in the packet, more granular decisions can be made for determining the optimal path. Yet alternatively, optimization of the path may be based on what the user is doing, such as the UTUBE example above.

While the embodiments and methods discussed herein have reference a multi-cloud environment, it is understood that they also apply to a single cloud environment.

FIG. 11 shows, in block diagram form, a relevant portion of a data center with network elements, in accordance with an embodiment and method of the invention. Physical networks 1702, switches/routers 1704, network service 2000, the distributed elastic receiver cluster 1520, SDN controller 1706 and cloud management platforms 1-N 1708 are shown in FIG. 7. The cluster 1520 is shown to include a router peer 1710. The cloud management platforms 1-N 1708 are analogous to the cloud management platform 304 of FIG. 3 and multiple platforms are to accommodate multiple clouds. Thus, “N” number of clouds can be accommodate with “N” being an integer value. SDN controller 1706 is analogous to the SDN controller 220 of FIG. 4.

The cluster 1520 pulls from the cloud management platforms 1-N 1708 virtual network state that is information about respective clouds' physical network, such as without limitation, the performance of computer or hardware onto which the virtual network is running and how the virtual network state information is performing. Stated differently, the cloud management platform 1-N 1708 is needed because of the multi-cloud characteristic of the system of FIG. 11 and because it is a virtualized environment. Thus, information such as how computes are performing, how virtual networks are performing and how hard the hardware, i.e. central processing unit, memory, . . . , onto which the virtualized machine is running is performing are important to track, for obvious reasons. Accordingly, this type of information is pushed onto the cluster 1520 from the platforms 1-N 1708.

SDN controller 1706 pushes network state information about the physical network, onto the cluster 1520. Network state information can also be directly retrieved from the physical switches, routers and other network elements 1704. Yet alternatively, the router peer 1710 can be added to collect routing information.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A fabric system comprising:
a service controller configured to communicate with a at least one of a plurality of services, the at least one of a plurality of services being in communication with an endpoint device, the service controller responsive to data packets from an open flow switch that is in communication with a client device, the data packets to take a predetermined sub-optimal path through services that are not identical to the at least one of a plurality of services, wherein based on policies, the services controller being operable to alter the predetermined path by re-directing the data packets to an altered path so as to minimize the number of services performed on the data packets and to inform an underlying network of the altered path.

2. The fabric system, as recited in claim 1, wherein the altered path is a substantially optimized services path for the packets of data through the network,

3. The fabric system, as recited in claim 1, wherein the services controller communicates with the open flow switch through an open flow controller.

4. The multi-cloud fabric system, as recited in claim 1, wherein the path is re-directed dynamically.

5. The fabric system, as recited in claim 4, wherein the re-direction is based on contents of at least some of the data packets.

6. The fabric system, as recited in claim 4, wherein the re-direction is based on historical information of at least some of the data packets from the policies.

7. The fabric system, as recited in claim 4, wherein the re-direction is based on information from the policies about the behavior of a user of the network.

8. The fabric system, as recited in claim 4, wherein the policies include user-defined policies

9. The fabric system, comprising:
a service controller responsive to a predetermined number of data packets, the predetermined number of data packets destined to travel through a path through services;
a storage location configured to maintain parameters, the parameters being associated with the predetermined number of packets, wherein based on the parameters, the services controller being operable to determine a substantially optimized service chain and re-direct the data packets through the substantially optimized service chain such that the data packets travel through an altered path with at least some altered services.

10. The fabric system, as recited in claim 9, wherein the re-directed path being saved by the services controller for use with subsequent data paths.

11. The fabric system, as recited in claim 9, wherein redundant services are bypassed based upon the endpoint device.

12. The fabric system, as recited in claim 9, wherein the substantially optimized service chain is dynamic.

13. The fabric system, as recited in claim 9, wherein packets of data are communicated between services of the substantially optimized service chain using TCP connections.

14. The fabric system, as recited in claim 12, wherein the re-directed path causes hijacking of the TCP connections.

15. The fabric system, as recited in claim 13, wherein the substantially optimized service chain includes a fully transparent proxy service.

16. The fabric system, as recited in claim 13, wherein the substantially optimized service chain includes a half transparent proxy service.

17. The fabric system, as recited in claim 13, wherein the substantially optimized service chain includes a fully non-transparent proxy service.

18. The fabric system, as recited in claim 13, wherein the substantially optimized service chain includes a half non-transparent proxy service.

19. The fabric system, as recited in claim 9, wherein the services controller is operable to communicate with an open flow switch through an open flow controller.

20. The fabric system, as recited in claim 9, wherein the path is re-directed dynamically.

21. The fabric system, as recited in claim 9, wherein the re-direction is based on contents of at least some of the data packets.

22. The fabric system, as recited in claim 9, wherein the re-direction is based on historical information of at least some of the data packets from the policies.

23. The fabric system, as recited in claim 13, wherein the re-direction is based on information from the policies about the behavior of a user of the network.

24. The fabric system, as recited in claim 13, wherein the policies include user-defined policies.

25. The fabric system, as recited in claim 9, wherein the storage location is within the services controller.

26. The fabric system, as recited in claim 9, wherein the storage location resides externally to the services controller.

27. The fabric system, as recited in claim 9, further including a PCRF, wherein the storage location is in the PCRF.

28. The fabric system, as recited in claim 9, wherein the fabric system is a part of a multi-cloud environment.

29. The fabric system, as recited in claim 9, wherein the fabric system is a part of a single cloud environment.
